(19) United States
(12) Patent Application Publication
(10) Pub. No.: US 2013/0272721 A1
(43) Pub. Date: Oct. 17, 2013

(54) OPTICAL NETWORK DEVICE EMPLOYING THREE-LEVEL DUOBINARY MODULATION AND METHOD OF USE THEREOF

(71) Applicant: ALCATEL-LUCENT USA, INC., Murray Hill, NJ (US)

(72) Inventors: Doutje van Veen, New Providence, NJ (US); Vincent E. Houtsma, New Providence, NJ (US); Peter J. Winzer, Aberdeen, NJ (US)

(73) Assignee: Alcatel-Lucent USA, Inc., Murray Hill, NJ (US)

(21) Appl. No.: 13/852,869

(22) Filed: Mar. 28, 2013

Related U.S. Application Data
(60) Provisional application No. 61/623,942, filed on Apr. 13, 2012.

(51) Int. Cl. H04B 10/60

(52) U.S. Cl. CPC H04B 10/60
USPC 398/202

(57) ABSTRACT

Introduced herein is an optical network device employing three-level duobinary modulation and a method of use thereof. One embodiment of an optical network receiver module includes: (1) an optical input configured to receive an optical non-return-to-zero (NRZ) signal having a data rate, and (2) an encoder having a maximum bandwidth, coupled to the optical input and configured to receive and encode the optical NRZ signal into an electrical three-level duobinary signal, the maximum bandwidth being related to, but substantially less than, the data rate.

### CROSS-REFERENCE TO RELATED APPLICATION

This application claims the benefit of U.S. Provisional Application Ser. No. 61/623,942, filed by van Veen, et al., on Apr. 13, 2012, entitled “25.8 G-PON Transmission over 40 km using Duobinary Detection with a Low Cost 7.5 GHz APD-Based Receiver,” commonly assigned with this application and incorporated herein by reference.

### TECHNICAL FIELD

This application is directed, in general, to optical network devices and, more specifically, to the use of duobinary modulation.

### BACKGROUND

Optical fiber is the backbone of many modern access networks. Optical fiber has several advantages over copper media, namely, lower attenuation and interference. Those advantages combined with falling costs and a broadening user base, have created a demand for more reliable and increasingly higher-bandwidth fiber optic networks.

Optical access networks, or simply optical networks, assume a variety of architectures, including passive optical networks (PONS) and active optical networks. Both PONS and active optical networks assume a star topology, where an optical line termination (OLT) at a service provider, or “upstream,” provides network access to multiple “downstream” end users via optical network units (ONUs). The distinction between PONS and active optical networks are where the optical lines from the service provider split into individual lines to reach end users. An active optical network uses electrically powered, or “active,” devices, or “nodes,” in the field to split and relay optical signals among the service provider and the end users; a PON uses unpowered, or “passive,” splitter devices. The trade-off is often perceived as reliability versus range. Generally speaking, a PON lacks the range capability of an active optical network, but is less vulnerable to failures because it employs more robust parts. In short, powered devices boost range, but are more susceptible to failure.

Cost is a significant factor in optical access networks. Architecting an optical access network may hinge on this alone. As the demand for bandwidth rises, so does cost. High-bandwidth components are expensive, and, when on the leading edge of high-bandwidth optical systems, scarce. Passive components can be less expensive than powered alternatives, but the nature and inherent obstacles of high-bandwidth optical access networks tends to dominate the cost structure.

### SUMMARY

One aspect provides an optical network receiver module, including: (1) an optical input configured to receive an optical non-return-to-zero (NRZ) signal having a data rate, and (2) an encoder having a maximum bandwidth, coupled to the optical input and configured to receive and encode the optical NRZ signal into an electrical three-level duobinary signal, the maximum bandwidth being related to, but substantially less than, the data rate.

Another aspect provides a method of generating a three-level duobinary signal having a data rate, including: (1) modulating a data signal onto an optical carrier signal, (2) employing a bandwidth limited device to at least partially generate the three-level duobinary signal, the bandwidth limited device having a maximum bandwidth related to but substantially less than the data rate, and (3) launching the three-level duobinary signal into an optical medium from which a bandwidth limited receiver receives and completes generation of the three-level duobinary signal, the bandwidth limited receiver having a maximum bandwidth related to but substantially less than the data rate.

Yet another aspect provides an optical network unit (ONU), including: (1) an optical input configured to receive, from an optical medium, an optical non-return-to-zero (NRZ) signal having a data rate, and (2) an avalanche photo-detector (APD) having a maximum bandwidth, coupled to the optical input and configured to receive and encode the optical NRZ signal into an electrical three-level duobinary signal, the maximum bandwidth being substantially equal to one-fourth of the data rate.

### BRIEF DESCRIPTION

Reference is now made to the following descriptions taken in conjunction with the accompanying drawings, in which:

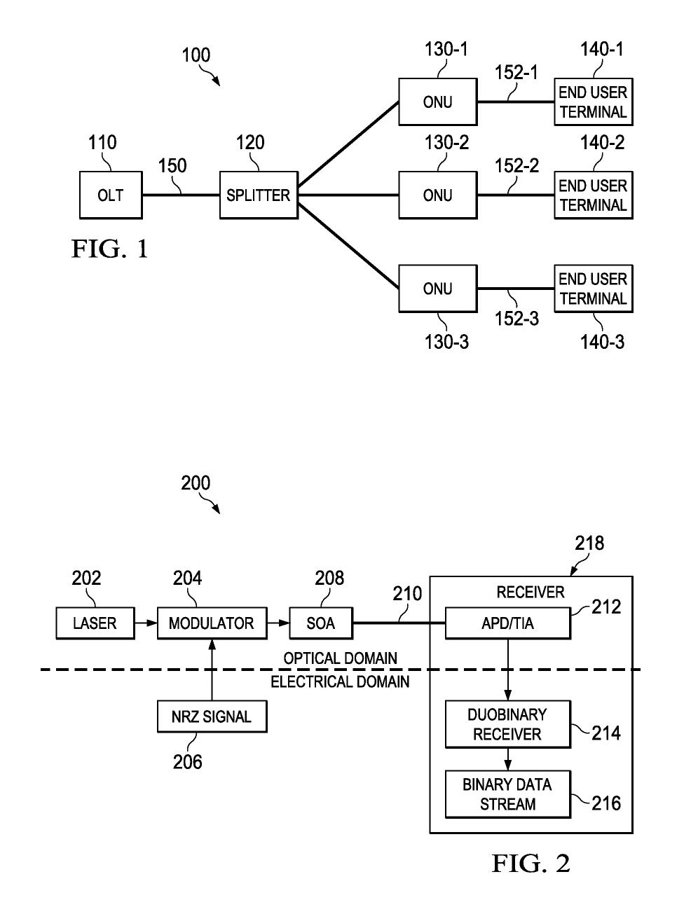

FIG. 1 is a block diagram of a passive optical network (PON);

FIG. 2 is a block diagram of one embodiment of an optical network employing duobinary modulation; and

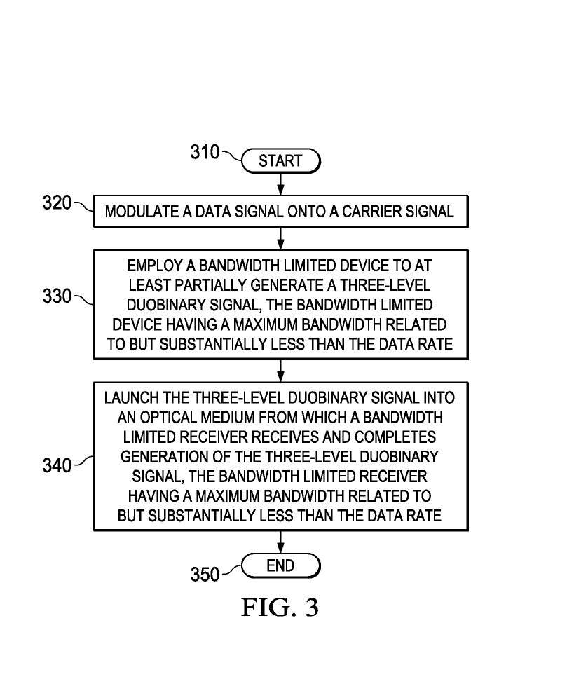

FIG. 3 is a flow diagram of one embodiment of a method of generating a three-level duobinary signal.

### DETAILED DESCRIPTION

A conventional optical network includes an optical line terminal (OLT) on the service provider's end (upstream) and multiple optical network units (ONUs) near the end users (downstream). Bandwidth demands in most optical access networks are asymmetric, meaning there is a greater demand for bandwidth in one direction than in the opposite. Bandwidth demand for data flowing downstream, toward the ONUs, tends to be greater than the bandwidth demand for upstream data flow, toward the OLT. There are several avenues for increasing the downstream data rates of optical networks, including higher performance components upstream and down, increasing the order of the modulation format or using multiple wavelengths.

When optical networks step up bandwidth and data rate capacity, they potentially expose themselves to additional noise and chromatic dispersion, which lead to bit errors. These issues are often overcome by utilizing higher order modulation schemes and data encoding, and likely require higher performance, higher quality components. Simply put, high bandwidth, high data rate optical networks can be expensive. Some approaches to increasing data rates include wavelength division multiplexing (WDM) and orthogonal frequency division multiplexing (OFDM) to mitigate obstacles like chromatic dispersion (CD) and low signal-to-noise ratio. These approaches generally require more expensive components than time division multiplexing (TDM). Increasing bit-rates downstream faces several obstacles: chromatic dispersion, sufficient optical power and cost. Non return to zero (NRZ) is a conventional modulation scheme in TDM optical networks. Increasing bit-rates of an NRZ signal requires increases in kind of downstream bandwidth. For instance, a rate, R, of 25.8 Gigabits per second (Gbps) requires ONUs containing transmitter and receiver components with a bandwidth of at least three-quarters of rate R, or about 20 GHz. Such high bandwidth components are prohibitively expensive for PON systems, if available at all.

Duobinary is an alternate modulation scheme to traditional NRZ modulation. Duobinary modulation allows for transmitting R bits per second (bps) using a modulation bandwidth of about 0.5 R, as opposed to the 0.75 R required for NRZ. Nyquist's theory implies duobinary signals will exhibit intersymbol interference (ISI). In fact, duobinary modulation does introduce ISI, but in a controlled fashion such that all data is recoverable. By allowing some ISI, the duobinary signal becomes smoother in the time domain, but narrower in the frequency domain, which also lends itself to improved dispersion performance (see, e.g., Shankar, “Duobinary Modulation for Optical Systems,” White Paper, Inphi Corporation, Pages: 1-10, December 2002).

An electrical duobinary modulated signal can be generated by passing an NRZ signal through an electrical delay and add filter, yielding a three-level signal existing in {1,0,−1}. The delay and add filter can be approximated by a well-chosen low pass filter having a bandwidth of about one-quarter the bit rate, R. It is realized herein three-level duobinary modulation, as an alternate to NRZ modulation, can yield high bit-rates by employing limited bandwidth components.

Optical networks may employ three-level duobinary signals by converting upstream and transmitting a three-level duobinary optical signal, or, it is realized herein, by transmitting a traditional NRZ modulated optical signal and converting to a three-level duobinary electrical signal downstream at the receiver. It is fundamentally realized herein that a transmitted three-level duobinary optical signal having a bit rate, R, requires receiver components with roughly half the bandwidth (R/2) of two-level duobinary or conventional NRZ signals at equivalent bit-rates. It is further realized herein that receiving an optical NRZ signal having a bit rate, R, with a bandwidth-limited receiving component, such that the signal is translated into a three-level duobinary electrical signal, requires that receiving component have a bandwidth equivalent to roughly one-quarter the bit rate. It is realized herein the bandwidth limited components in either embodiment are less susceptible to chromatic dispersion and are readily available.

It is realized herein that conversion at the transmitter yields slightly better chromatic dispersion performance while conversion at the receiver yields better optical receiver sensitivity due to lower noise equivalent bandwidth. It is also realized herein that chromatic dispersion introduced by increased bit-rates may be alleviated by transmitting in the O-frequency band (wavelengths ranging from 1260 nanometers to 1380 nanometers).

It is fundamentally realized herein the ONUs may employ bandwidth limited avalanche photo-detector (APD) based receivers as NRZ-to-duobinary converters. It is further realized herein that receiver performance is finely tunable by selecting appropriately bandwidth limited components.

It is realized herein that in duobinary systems, precoding data at the transmitter is necessary to reduce error propagation and to simplify the receiver circuitry. It is also realized herein that employing wavelength stacking in combination with the three-level duobinary modulation allows bit-rates in excess of 100 Gbps.

Before describing various embodiments of the optical network devices or method introduced herein, an optical network within which the optical network devices and method introduced herein may be embodied or carried out will be generally described.

FIG. 1 is a block diagram of a PON 100 within which the optical network devices or method may be embodied or carried out. PON 100 includes an OLT 110, a splitter 120, and multiple ONUs 130-1, 130-2 and 130-3, coupled to respective end user terminals 140-1, 140-2 and 140-3. OLT 110 is coupled to splitter 120 by a fiber line 150, such as a standard single-mode fiber (SSMF) optical medium. Splitter 120 distributes downstream data flows among the various ONUs and end users, and gathers upstream data flows from the various ONUs and end users. Splitter 120 is coupled to ONUs 130-1, 130-2 and 130-3 by additional fiber line. An ONU 130 typically converts the downstream signal from an optical signal into an electrical signal, such that it can be easily distributed to end users. Likewise, the ONU 130 converts upstream signals from electrical to optical. ONUs 130-1, 130-2 and 130-3 are respectively coupled to end user terminals 140-1, 140-2 and 140-3 by network cables 152-1, 152-2 and 152-3. A network cable 140 is typically a copper twisted pair cable or a coaxial cable. In certain embodiments, an optical connection may run directly to an end user terminal 140, but copper is more common.

Having generally described a PON within which the optical network devices or method introduced herein may be embodied or carried out, various embodiments of the optical network devices and method will be described.

FIG. 2 is a block diagram of one embodiment of an optical network 200 having a transmit side coupled to a receiver 220 by a fiber line 212. The transmit side includes a laser 202, a modulator 204, a NRZ data signal 206 and a semiconductor optical amplifier (SOA) 208. Receiver 218 includes an avalanche photo-detector/trans-impedance amplifier (APD/TIA) 212, a duobinary receiver 214 and a binary data stream 216.

On the transmit side, laser 202 is a continuous wave light source onto which NRZ data signal 206 is modulated by modulator 204. In certain embodiments, laser 202 is an O-band distributed feedback (DFB) laser. Other embodiments may employ direct modulation of the DFB laser current, thus obviating modulator 204. Various alternate embodiments may employ a variety of other types of lasers operable in various other bands in the light spectrum, including: E-band, S-band, C-band, L-band and U-band.

Optical networks are often employed over long distances, which makes it necessary to amplify the modulated signal. SOA 208 serves that purpose here. SOA 208 amplifies the modulated optical signal from modulator 204 and injects it into fiber line 210. SOA 208, in other embodiments, may be substituted for any optical amplifier appropriately rated for the length of transmission and wavelength. In alternate embodiments that experience low attenuation, for example, over short distances, SOA 208 may be omitted altogether.

Receiver 218 receives the transmitted optical signal via APD/TIA 212. APD/TIA 212 is a bandwidth limited device, having a maximum bandwidth of roughly one-quarter the data rate: R/4 Hz. As the attenuated optical signal passes through APD/TIA 212, it is effectively low pass filtered, yielding a three-level duobinary electrical signal. In alternate embodiments, the bandwidth may be larger than R/4 Hz, but maintains low pass filter characteristics. Other embodiments may employ different optical receivers, such as a positive intrinsic negative (PIN) diode or other photo-diode.

In the embodiment of FIG. 2, the three-level duobinary electrical signal is recovered by duobinary receiver 214, thereby producing binary data stream 216. In alternate embodiments, the bandwidth of APD/TIA 212 is limited to the extent that it only partially approximates the low-pass filter necessary to perform the duobinary conversion. In those embodiments, the bandwidth of APD/TIA 212 is paired with a bandwidth limited device on the transmit side. On the transmit side, this device could be modulator 204, or, more specifically, a bandwidth limited Mach-Zehnder modulator (MZM). The transmit side may also employ a bandwidth limited driver module or a bandwidth limited optical transmitter.

FIG. 3 is a flow diagram of one embodiment of a method of generating a three-level duobinary signal. The method begins at a start step 410. A data signal is modulated onto an optical carrier signal at step 420. In certain embodiments, the data signal is an NRZ modulated electrical signal. In other embodiments the data signal is pre-coded to make the system more robust and less error prone. Also, in certain embodiments the modulating device is a Mach-Zehnder modulator, while other embodiments may employ a variety of other modulation techniques, including direct modulation.

Continuing the embodiment of FIG. 3, at step 330, a bandwidth limited device is employed such that as the signal passes through the device, the device operates as a filter, partially converting the signal to a three-level duobinary signal. In certain embodiments, the bandwidth limited device may be a signal driver configured to amplify the data signal prior to modulation. In other embodiments the bandwidth limited device may be the optical transmitter itself that generates continuous wave light. In any case, the bandwidth limited device has a maximum bandwidth that is related to but substantially less than the data rate of the data signal. For purposes of the invention, the maximum bandwidth is “substantially less” than the data rate when the maximum bandwidth is at most 90% of the data rate. In one embodiment, the maximum bandwidth is “substantially less” than the data rate when the maximum bandwidth is about half of the data rate. In another, narrower embodiment, the maximum bandwidth is “substantially less” than the data rate when the maximum bandwidth is about one-fourth of the data rate.

At step 340 the NRZ or partially converted three-level duobinary signal is launched into an optical medium towards a bandwidth limited optical receiver. Similar to the bandwidth limited device mentioned above, upon receipt of the partially converted three-level duobinary optical signal, the bandwidth limited receiver operates as a filter, completing the duobinary conversion. The bandwidth limited receiver has a maximum bandwidth that is related to but substantially less than the data rate of the data signal. The filtering effects of the bandwidth limited device and the bandwidth limited receiver combine to approximate the low-pass filter necessary for duobinary conversion. The method ends at step 450. In certain embodiments the optical medium is a standard single-mode fiber (SSMF), however other media are possible.

Those skilled in the art to which this application relates will appreciate that other and further additions, deletions, substitutions and modifications may be made to the described embodiments.

What is claimed is:

1. An optical network receiver module, comprising:
an optical input configured to receive an optical non-return-to-zero (NRZ) signal having a data rate; and
an encoder having a maximum bandwidth, coupled to said optical input and configured to receive and encode said optical NRZ signal into an electrical three-level duobinary signal, said maximum bandwidth being related to, but substantially less than, said data rate.

2. The optical network receiver module recited in claim 1 wherein said encoder comprises a bandwidth-limited avalanche photo-detector (APD).

3. The optical network receiver module recited in claim 1 wherein said encoder comprises a bandwidth-limited Positive Intrinsic Negative (PIN) diode.

4. The optical network receiver module recited in claim 1 wherein said encoder comprises a trans-impedance amplifier (TIA).

5. The optical network receiver module in claim 1 wherein said optical NRZ signal has a wavelength between about 1260 nanometers and about 1380 nanometers.

6. The optical network receiver module recited in claim 1 wherein said optical input is configured to receive said optical NRZ signal on a single-mode fiber optical medium of at least 40 kilometers in length.

7. The optical network receiver module recited in claim 1 wherein said maximum bandwidth is about one-fourth of said data rate.

8. The optical network receiver module recited in claim 1 further comprising a duobinary receiver coupled to said encoder and operable to convert said electrical three-level duobinary signal into a bit stream having said data rate.

9. A method of generating a three-level duobinary signal having a data rate, comprising:
modulating a data signal onto an optical carrier signal;
employing a bandwidth limited device to at least partially generate said three-level duobinary signal based on said data signal, said bandwidth limited device having a maximum bandwidth related to but substantially less than said data rate; and
launching the partial three-level duobinary signal into an optical medium from which a bandwidth limited receiver receives and completes generation of said three-level duobinary signal, said bandwidth limited receiver having a maximum bandwidth related to but substantially less than said data rate.

10. The method recited in claim 9 wherein said modulating is carried out by a Mach-Zehnder Modulator (MZM).

11. The method recited in claim 9 wherein said modulating is carried out by modulating the laser bias current.

12. The method recited in claim 9 wherein said data signal is a non return to zero (NRZ) signal.

13. The method recited in claim 9 wherein said maximum bandwidth is about half said data rate.

14. The method recited in claim 9 wherein said bandwidth limited device is an optical transmitter operable to carry out said launching.

15. The method recited in claim 9 wherein said bandwidth limited device is an amplifier and said employing said bandwidth limited device is carried out before said modulating.

16. The method recited in claim 9 wherein said method further comprises pre-coding said data signal.

17. An optical network unit (ONU), comprising:
an optical input configured to receive, from an optical medium, an optical non-return-to-zero (NRZ) signal having a data rate; and
an avalanche photo-detector (APD) having a maximum bandwidth, coupled to said optical input and configured to receive and encode said optical NRZ signal into an electrical three-level duobinary signal, said maximum bandwidth being substantially equal to one-fourth of said data rate.

18. The ONU recited in claim 17 wherein said optical medium is a standard single-mode fiber (SSMF) channel.

19. The ONU recited in claim 17 wherein said ONU further comprises a trans-impedance amplifier (TIA) proximately coupled to said APD.

20. The ONU recited in claim 17 wherein said optical NRZ signal has a wavelength between about 1260 nanometers and about 1380 nanometers.

21. The ONU recited in claim 17 wherein said optical NRZ signal is precoded.

22. The ONU recited in claim 17 wherein said ONU further comprises a duobinary receiver operable to carry out clock-data recovery (CDR).

23. A method of generating a three-level duobinary signal having a data rate, comprising:
modulating a data signal onto an optical carrier signal;
launching the modulated signal into an optical medium; and
employing a bandwidth limited receiver to receive the modulated signal, thereby generating said three-level duobinary signal, said bandwidth limited receiver having a maximum bandwidth related to but substantially less than said data rate.
